(19) United States
(12) Patent Application Publication
(10) Pub. No.: US 2026/0073428 A1
(43) Pub. Date: Mar. 12, 2026

(54) Systems and Methods For Preparation And Retrieval Of User-Level Treatment Recommendations From A Machine Learning Model

(71) Applicant: Auxia, Inc., Los Altos Hills, CA (US)

(72) Inventors: Ravi Desu, Los Altos Hills, CA (US); Sumeet Kumar, San Jose, CA (US); Asim Krishna Prasad, Bengaluru (IN); Yichen Zhao, Santa Clara, CA (US)

(21) Appl. No.: 19/070,383

(22) Filed: Mar. 4, 2025

Related U.S. Application Data
(60) Provisional application No. 63/691,863, filed on Sep. 6, 2024.

(51) Int. Cl. G06Q 30/0251; G06N 20/00

(52) U.S. Cl. CPC G06Q 30/0271; G06N 20/00; G06Q 30/0255

(57) ABSTRACT

Disclosed herein is a computerized method including operations of receiving a request for a treatment recommendation, where the request includes a user ID and where a treatment is a notification, alert, or message to be provided by a network device. The operations further include retrieving a set of user data from an aggregated user data table according to the user ID and treatment data comprised of data related to a set of predefined treatments from a treatment datastore, determine a score for each of the set of candidate treatments through processing of the set of user data, a set of candidate treatments, and a configured objective as input by a machine learning model, generating a ranked list of treatments based on the scoring provided by the machine learning model, and providing the ranked list of the set of candidate treatments and the set of candidate treatments to the network device.

### CROSS-REFERENCE TO RELATED APPLICATIONS

This application claims the benefit of priority on U.S. Provisional Application No. 63/691,863 filed Sep. 6, 2024, the entire contents of which are incorporated herein by reference.

### FIELD

Embodiments of the disclosure relate to the field of digital platform generation. More specifically, one embodiment of the disclosure relates to a system for determining aspects of digital platforms that are to be physically or audibly rendered on a network device of an end user based on features generated from user data and predefined treatments.

### BACKGROUND

Digital platforms provide media for which data may be exchanged between users and/or companies. For instance, a business-to-consumer (B2C) digital platform may include any digital medium through which a business interfaces with a consumer. Examples in today's society include a website, an email, a dedicated software application that processes on an endpoint device of the consumer (“app”), etc. The data exchanged often depends on the B2C platform media, the business, and optionally, a business objective (e.g., prompting a consumer to buy a particular good that the consumer previously placed in a digital shopping cart).

As is often the case today, businesses that utilize a digital platform to engage with consumers typically transmit emails with targeted advertisements or targeted text directing the consumer to take a particular action such as shop for a sale item or finish purchasing an item placed in a digital shopping cart. Additionally, a business may send notifications or display targeted text or images within their app for a consumer. A business may track the specific items that the consumer browsed on the business's website or within the business's app, transactions that the consumer made with the business, and in many instances, clicks, views, share, and/or other user input within a website and/or app.

While businesses often track various aspects of what has become known to be called “consumer data,” on each consumer thereby providing very personalized metadata on each consumer, businesses typically interface with each consumer in the same manner. For example, while the items in two digital shopping carts of two consumers may vary, the emails provided to the two consumers are typically provided in the same manner such as at a predetermined time after the consumer's last action within the website or app (e.g., 60 minutes after the consumer's last click) and adhere to the same template having the same text but for the specifics of the items in each consumer's digital shopping cart.

Consumers are not robotic and do not engage with a digital platform of a business in the same way as each other. While a standard, templated email reminding one to finish checking out their digital shopping cart may prompt a first consumer to complete the purchase action, a second consumer may completely disregard emails but instead may have been persuaded to complete the purchase of their digital shopping cart had the second consumer been prompted via a push notification from the app. Thus, in today's digital platform environment, businesses are failing to successfully and efficiently engage with consumers in ways made possible through analysis of the consumer data.

### BRIEF DESCRIPTION OF THE DRAWINGS

Illustrative examples are described in detail below with reference to the following figures:

FIG. 1 is a system diagram of interactions between a treatment selection engine and a third-party digital platform based on event data, user attributes, and treatment content and configurations according to some embodiments;

FIG. 2 is a logic diagram of the treatment selection engine of FIG. 1 according to some embodiments;

FIG. 3A is a data flow during a user feature creation process according to some embodiments;

FIG. 3B is detail as to the generation of user feature embeddings according to some embodiments;

FIGS. 3C-3F provide an example of a transformer architecture configured and trained for specific purposes according to some embodiments;

FIG. 4A is a data flow during a treatment feature creation process according to some embodiments;

FIG. 4B is detail as to the generation of treatment feature embeddings according to some embodiments;

FIG. 5 is a flowchart illustrating operations of a process for training a machine learning model with user feature embeddings and treatment feature embeddings according to some embodiments;

FIG. 6 is a data flow for performing a treatment recommendation based on user feature embeddings and treatment feature embeddings according to some embodiments;

FIG. 7 is a diagrammatic illustration of a data flow resulting from receipt of a treatment request according to some embodiments;

FIG. 8 is a detailed logic diagram of the treatment selection engine according to some embodiments;

FIG. 9 is a subset of the logic diagram of FIG. 8 illustrating logic modules utilized in determining a treatment recommendation according to some embodiments;

FIG. 10 is a flowchart illustrating operations of a process for determining a treatment recommendation according to some embodiments;

FIG. 11A is a flowchart illustrating operations of an optional process for applying eligibility rules to a set of predefined treatments resulting in a candidate subset of treatments according to some embodiments;

FIG. 11B is a subset of the logic diagram of FIG. 8 illustrating logic modules utilized in the process of FIG. 11A of applying eligibility rules to a set of predefined treatments according to some embodiments;

FIG. 12A is a flowchart illustrating operations of deploying a machine learning model to score a candidate subset of treatments according to some embodiments;

FIG. 12B is a subset of the logic diagram of FIG. 8 illustrating logic modules utilized in the process of FIG. 12A of deploying a machine learning model to score a candidate subset of treatments according to some embodiments;

FIG. 13 is a flowchart illustrating operations of applying a set of mutual exclusion rules to a ranked list of candidate subset of treatments according to some embodiments; and

FIGS. 14A-14C illustrate example treatments according to some embodiments.

### DETAILED DESCRIPTION

### I. Terminology

In the following description, certain terminology is used to describe various features of the invention. For example, each of the terms “logic,” “engine,” and “component” may be representative of hardware, firmware or software that is configured to perform one or more functions. As hardware, the term logic (or component) may include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the logic (or component) may include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to, a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

Herein, a “communication” generally refers to related data that is received, transmitted, or exchanged within a communication session. The data may include a plurality of packets, where a “packet” broadly refers to a series of bits or bytes having a prescribed format. Alternatively, the data may include a collection of data that may take the form of an individual or a number of packets carrying related payloads, e.g., a single webpage received over a network.

The term “computerized” generally represents that any corresponding operations are conducted by hardware in combination with software and/or firmware.

The term “object” generally relates to content (or a reference to access such content) having a logical structure or organization that enables it to be classified for purposes of analysis as a cyberthreat such as malware or phishing. The content may include an executable (e.g., an application, program, code segment, a script, dynamic link library “dll” or any file in a format that can be directly executed by a computer such as a file having an extension of “.exe”, “.vbs”, “.js”, etc.), a non-executable (e.g., a storage file; any document such as a Portable Document Format “PDF” document; a word processing document such as WORD® document; an electronic mail “email” message, web page, etc.), or simply a collection of related data. Additionally, the term object may refer to an instance of an executable that is executing (“a process”). In one embodiment, an object may be an image data such as one or more images and/or videos. In another embodiment, an object may be a set of instructions that are executable by one or more processors. The object may be retrieved from information in transit (e.g., one or more packets, one or more flows each being a plurality of related packets, etc.) or information at rest (e.g., data bytes from a storage medium).

Examples of objects may include one or more flows or a self-contained element within a flow itself. A “flow” generally refers to related packets that are received, transmitted, or exchanged within a communication session. For convenience, a packet is broadly referred to as a series of bits or bytes having a prescribed format, which may, according to one embodiment, include packets, frames, or cells. Further, an “object” may also refer to individual or a number of packets carrying related payloads, e.g., a single webpage received over a network. Moreover, an object may be a file retrieved from a storage location over an interconnect. As a self-contained element, the object may be an executable (e.g., an application, program, segment of code, dynamically link library “DLL”, etc.) or a non-executable. Examples of non-executables may include a document (e.g., a Portable Document Format “PDF” document, MICROSOFT® OFFICE® document, MICROSOFT® EXCEL® spreadsheet, etc.), an electronic mail (email), downloaded web page, or the like.

The term “network device” may be construed as any electronic computing system with the capability of processing data and connecting to a network. Such a network may be a public network such as the Internet or a private network such as a wireless data telecommunication network, wide area network, a type of local area network (LAN), or a combination of networks. Examples of a network device may include, but are not limited or restricted to, an endpoint (e.g., a laptop, a mobile phone, a tablet, a computer, etc.), a standalone appliance, a server, a router or other intermediary communication device, a firewall, etc.

The term “rules” refers to logic used in executing certain operations, wherein execution may vary (or not occur) based on a rule. Each rule is capable of being represented as a logical expression for example, such as an “if this, then that” statement, where “this” represents a condition, and “that” represents the conclusion. The conclusion is applied when the condition is met by analysis of parameters (predetermined or dynamically obtained). The term “implicated rules,” as used herein, are the one or more specific rules applied in reaching a verdict, reflecting predetermined or dynamically obtained parameters and the conclusions drawn from them based on the logical expressions.

The term “treatment” refers to a communication provided to a user via a network device such as an alert, an electronic mail message (“email”), a banner displayed within a software application (“app”), a banner presented on a home screen or lock screen of a network device, an alert displayed on a network-enabled watch that is communicatively coupled to a mobile phone (e.g., a “smart watch”), etc. A treatment may include text or graphics that are specific to services or goods provided by a third-party application or entity with some examples including groceries, shoes and apparel, language learning, etc. However, treatments are not limited to these example services or goods and may be applicable to all third-party applications that provide alerts, emails, banners, etc., to users. In some embodiments, a treatment may be specific to a particular user, e.g., the text customized to the user based on prior purchases or use of the third-party application. In other embodiments, the text need not be customized to a particular user.

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. Generation of Training Data and Training of Machine Learning Models

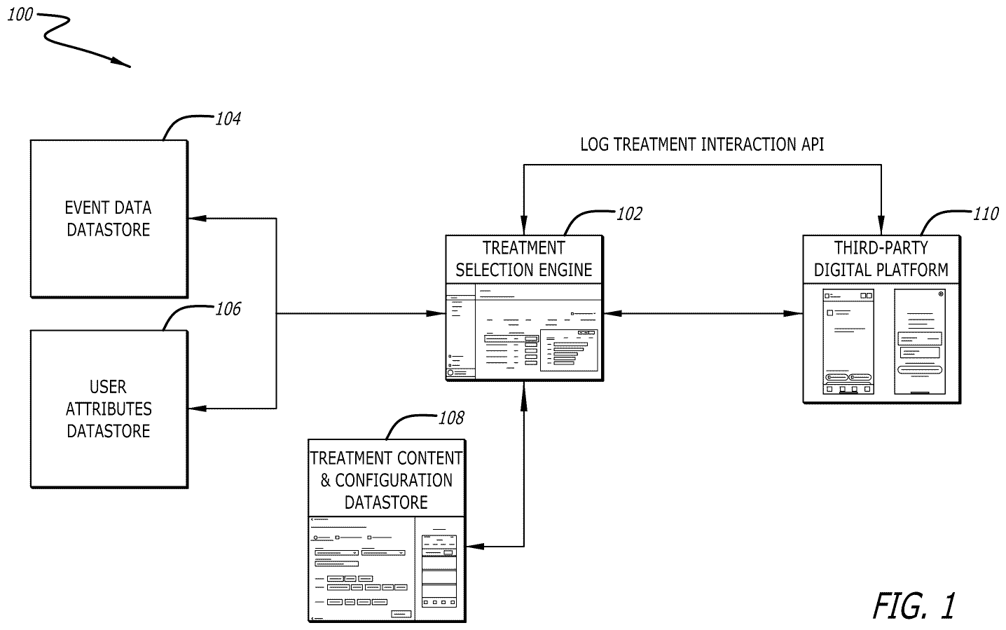

Referring now to FIG. 1, a system diagram of interactions between a treatment selection engine and a third-party digital platform based on real-time event data, user attributes, and treatment content and configurations is shown according to some embodiments. FIG. 1 illustrates a networked environment 100 that includes various data components configured to interact electronically resulting in generation of a treatment recommendation that is provided to a third-party digital platform 110. More specifically, a treatment selection engine 102 is configured to receive a treatment request from the third-party digital platform 110 via an application programming interface (API). In some instances, a treatment request is received from logic of the third-party digital platform 110 processing on remote or cloud computing resources and that is configured to monitor and manage accounts and instances of apps processing on individual network devices. In other instances, a treatment request may be received from an individual instance of an app processing on an individual network device. While the several examples are discussed herein and illustrated in the accompany that include the initiation of a process in which a treatment recommendation is initiated in response to receipt of a treatment request by the treatment selection engine 100, the processes for generating treatment recommendations may be initiated automatically, e.g., at periodic or aperiodic intervals, or in response to user input requesting such.

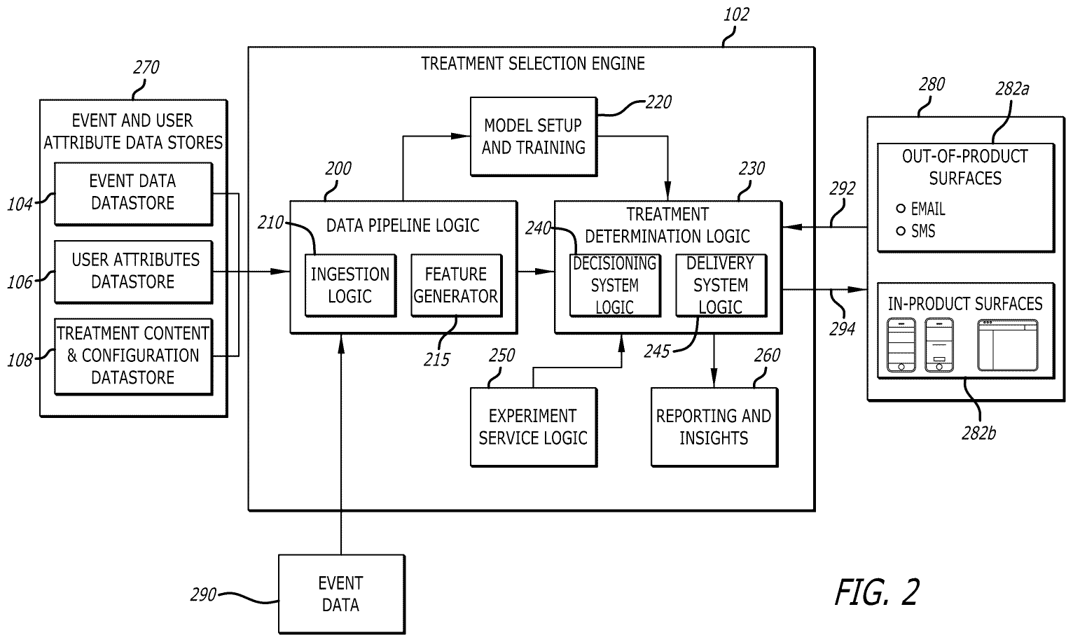

As will be discussed in detail below, the treatment selection engine 102 is comprised of several logic components and is communicatively coupled with datastores such as an event data datastore 104, a user attribute datastore 106, and a treatment content and configuration datastore 108. At a high level, the logic components of the treatment selection engine 102 are configured to receive a treatment request from third-party digital platform 110 and perform a series of operations that include processing by a data pipeline logic and a treatment determination logic (as discussed with respect to FIG. 2) resulting in a recommendation of one or more treatments to be provided to a user via display screens of one or more network devices.

As one illustrative example, a third-party application may be that of a grocery store (“grocery app”), where the grocery app is configured to provide users with information as to weekly or monthly sales, current promotions, etc. and also receive user input corresponding to a digital purchase of items. For instance, a user may open the grocery app on a network device such as a mobile device, review a weekly flyer that lists various sales and promotions, add items to a digital cart, and electronically checkout thereby purchasing the items in the digital cart such as by providing credit card or other payment information. The purchased items may be delivered to or picked-up by the user.

While the grocery store may at times send treatments to the user through the grocery app (e.g., a banner when the app is opened or to a home/lock screen of a network device on which the grocery app is installed) or by email, the treatments may be sent at inopportune times for the user or may sent in a manner not preferred by the user. For example, the user may check emails often or have little interest in visiting a link set forth in an email, even if the link provides a discount on items typically purchased by the user. However, the same user may be more likely to utilize the discount if provided via a banner when the user opens the grocery app. Thus, the treatment selection engine 102 utilizes event data, user attributes, and predefined treatment templates to provide a treatment recommendation as to which one or more treatments to provide the user, and optionally, a timing of the treatment(s).

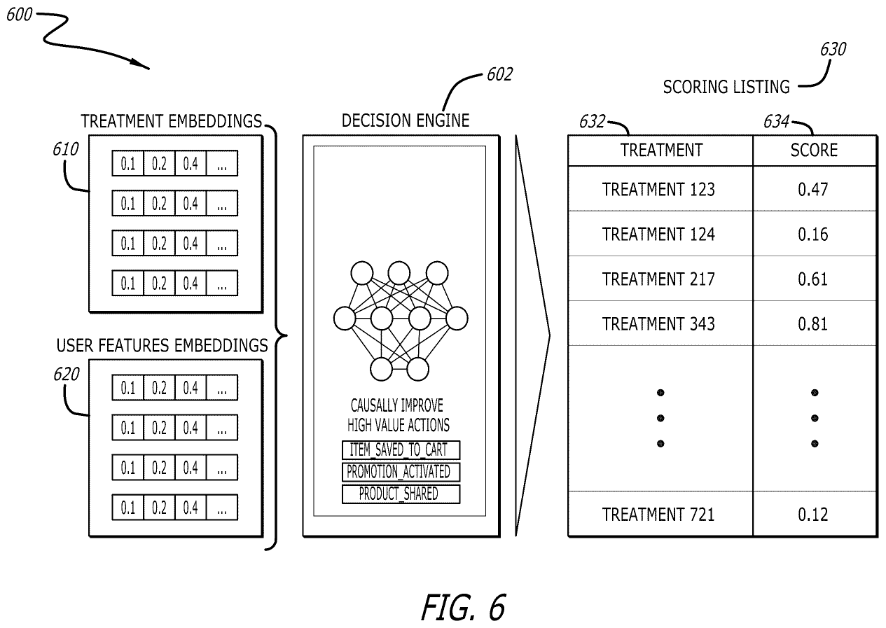

As discussed below with respect to at least FIGS. 6-14C, the treatment selection engine 102 utilizes machine learning techniques to generate the treatment recommendation. For example, the treatment selection engine 102 may comprises a plurality of machine learning models, where a selected machine learning model is configured to receive input comprising user attributes, historical user data, and a set of candidate treatments as discussed below and generate a score for each of the candidate treatments representative of a likelihood that the user will initiate an action based on being provided with the treatment.

Additionally, as discussed below with respect to at least FIGS. 2-5, the plurality of the machine learning models deployed by the treatment selection engine 102 are trained through an innovative procedure resulting in trained machine learning models configured to receive specific input, e.g., user attributes, historical user data, and a set of candidate treatments, and generate a score for each of the set of candidate treatments. As discussed below, the training data used in training the plurality of machine learning models may include historical user event data and user attribute data, which may be subjected to an operation of removing personally identifiable information (PII), operations of feature engineering and deep learning to obtain aggregated features and vector embeddings, respectfully. Additionally, historical treatments may also be included in the training data and subjected to processing by machine learning models resulting in vector embeddings. The combined training data of aggregated features and vector embeddings corresponding to historical user event data and user attribute data and vector embeddings of historical treatments is then utilized in training the plurality of machine learning models.

Referring now to FIG. 2, a logic diagram of the treatment selection engine of FIG. 1 is shown according to some embodiments. FIG. 2 provides a detailed view of logic modules comprising the treatment selection 102 including a data pipeline logic 200, a model setup and training pipeline 220, a treatment determination logic 230, an experiment service logic 250, and a reporting and insights service 260. The data pipeline logic 200 may include an ingestion logic 210 and a feature generator 215. The treatment determination logic 230 may include a decisioning system logic 240 and a delivery system logic 245. FIG. 2 illustrates that the data pipeline logic 200 is configured to interface with event and user attribute datastores 270, which is comprised of the event data datastore 104, the user attributes data store 106, and the treatment content and configuration datastore 108. Further, FIG. 2 illustrates that the treatment determination logic 230 is configured to receive treatment requests from a third-party digital platform 280 and provide treatment recommendations as discussed herein. In some examples, the recommended treatments may be provided in out-of-product surfaces 282a such as emails or text messages (short message service, “SMS”) or in-product surfaces 282b such as display screens within the third-party app.

The ingestion logic 210, upon execution by one or more processors, may be configured to perform operations including receiving event data 290 that is recorded by the third-party app and which may include user behavioral data being user clicks within the third-party app or in out-of-product surfaces and user purchase information along with date and timestamps for each click and purchase. User purchase information may include item price and coupon usage. The event data 290 may be received as a table data structure comprising rows and columns of data, e.g., Google's BigQuery, or through a messaging service, e.g., Google Cloud Pub/Sub. The ingestion logic 210 may also be configured, upon execution by one or more processors, to perform operations such as aggregation of a number of purchases within a given time period, a monetary amount of the purchase within the given time period, or a number of clicks within the given time period. The aggregates may then be stored in the event and user attribute datastores 270.

The feature generator 215, upon execution by one or more processors, may be configured to perform operations including removal of PII. For example, a third-party may configure the treatment selection engine 102 to parse the event data 290 to identify and remove fields such as names, email, phone numbers, location, etc., by erasing the field values in the ingestion pipeline prior to any additional processing and stored by the treatment selection engine 102.

Additionally, as discussed above, the feature generator 215, upon execution by one or more processors, may be configured to perform additional operations including performing feature engineering including extracting predefined features from the data stored in the datastores 270 including aggregated features of: the number of days since a free trial of a paid subscription started; average order/purchase value; referral source; last purchased category; etc. Further, the feature generator 215, upon execution by one or more processors, may be configured to perform additional operations including generating vector embeddings from event data and user attributes through the deployment of deep neural networks and/or transformers, which are a class of machine learning models typically used in natural language processing (NLP) such as bidirectional encoder representations from transformers (BERT) models or generative pre-trained transformers (GPT). Additionally, the feature generator 215, upon execution by one or more processors, may be configured to perform additional operations including generating vector embeddings representative of the historical treatments provided to a user corresponding to the event data 290 through deployment of deep neural networks and/or transformers referenced above. The vector embeddings may be representative of semantic meaning and relationships between aspects of: (i) the event data and user attributes; and (ii) historical treatments. The aggregated features and vector embeddings may be combined to form training data.

The model setup and training pipeline 220, upon execution by one or more processors, may be configured to perform operations including train one or more machine learning models using training data, which may be generated in the manner discussed above.

The decisioning system logic 240, upon execution by one or more processors, may be configured to perform operations including obtaining user attribute data, user event data, possible treatments, treatment history of a particular user associated with the treatment request 292. The decisioning system logic 240 may apply eligibility rules to filter the possible treatments to a candidate subset of treatments, and provide the candidate subset of treatments, user attribute data, user event data, and treatment history to a machine learning model that is selected based on the training and configuration of the model such as to score treatments according to a likelihood to cause user behavior toward a desired action (or objective). The decisioning system logic 240 may then generate a ranked list of the candidate subset of treatments based on the scoring while also optionally applying ranking rules (or logic), which may alter the position of one or more treatments on the ranked list. The ranked list and the treatments appearing on the list may then be provided to the delivery system logic 245.

The delivery system logic 245, upon execution by one or more processors, may be configured to perform operations including receiving treatment requests 292 from and transmitting treatment recommendations 294 to the third-party digital platform 280. For instance, the delivery system logic 245 may interface with various third-party digital platforms via different APIs. Further, the delivery system logic 245 may parse a treatment request to extract certain data components such as a user ID, a timestamp, an indication of the network device(s) on which the third-party app is installed (e.g., a mobile device, a tablet, etc.) as such may influence the available treatments (e.g., certain treatments may be formatted specifically for tablets or for mobile devices based on screen size), an indication of an operating system processing on the network device or of a version of the third-party app is installed as such may influence the available treatments. The delivery system logic 245 may also format the treatment recommendations 294 according to an applicable API being used to transmit a treatment recommendation and one or more treatments from the treatment selection engine 102 to a third-party digital platform 280. In some instances, the third-party digital platform 280 may be a cloud-hosted software platform that relays the recommended treatment(s) to one or more network devices on which the third-party app is installed (e.g., on a tablet and a mobile device of a user) and/or to webpage code that causes display of a recommended treatment when the webpage is accessible by the user.

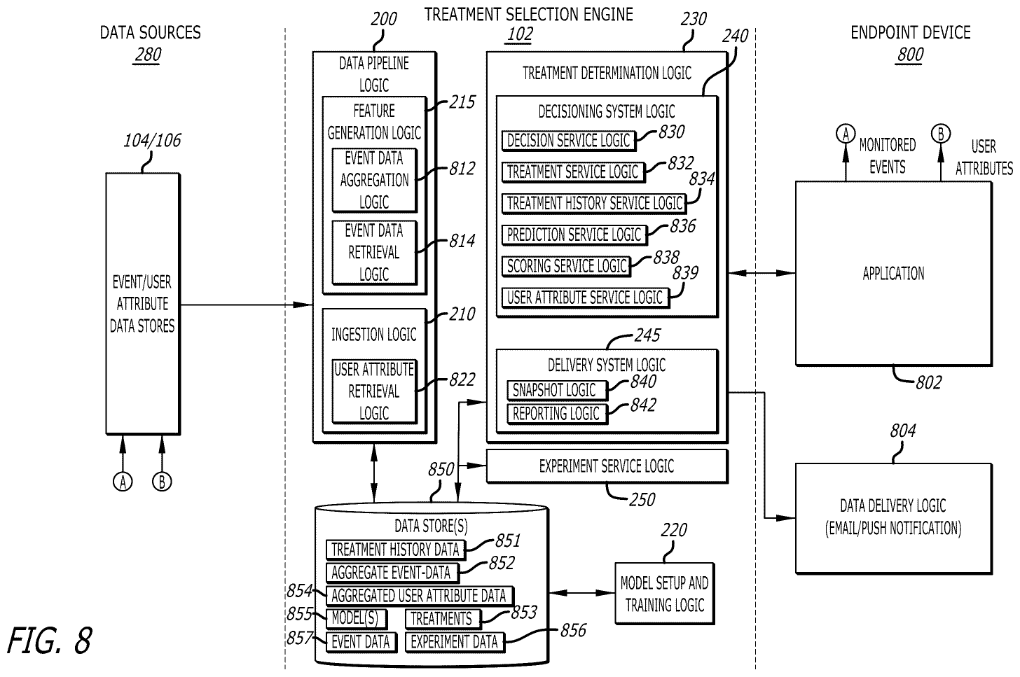

The experiment service logic 250, upon execution by one or more processors, may be configured to perform operations including performing an experimentation process through the use of a plurality of treatment recommendation determination methodologies. For example, as discussed below, a third-party digital platform may request a treatment recommendation 292 for one or more treatments to be provided to a particular user, where the treatment recommendation 292 includes a user identifier. The decision system logic 240 may query the experiment service logic 250 to determine to which experiment group the user belongs, where an experiment group may refer to the methodology used to determine the treatment recommendation such as any of a plurality of machine learning models, a heuristic approach, a random approach, or a control group (e.g., for which a treatment may not be returned, a default treatment may be returned, or a response without a recommended treatment may be returned). The experiment service logic 250 may store a listing for the third-party digital platform of users that includes a pairing of a user identifier and an experiment group. The decision system logic 240 then relays such information to the prediction service logic 836 of FIG. 8, which is configured to select a machine learning model for deployment.

The reporting and insights logic 260, upon execution by one or more processors, may be configured to perform operations including aggregations and calculations of key metrics like views, clicks, target action taken, conversion etc. by key groupings like date, treatments, country etc.

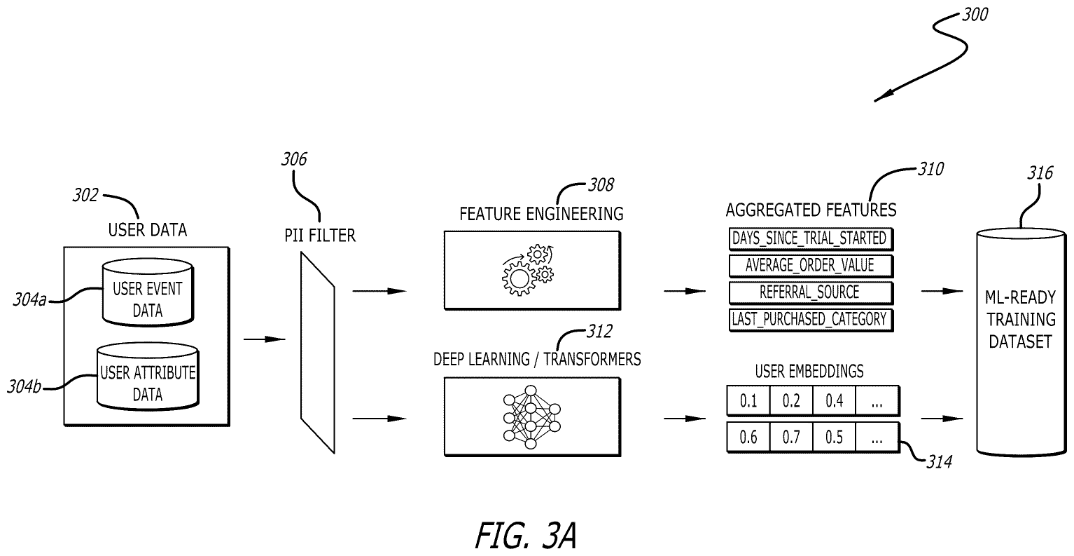

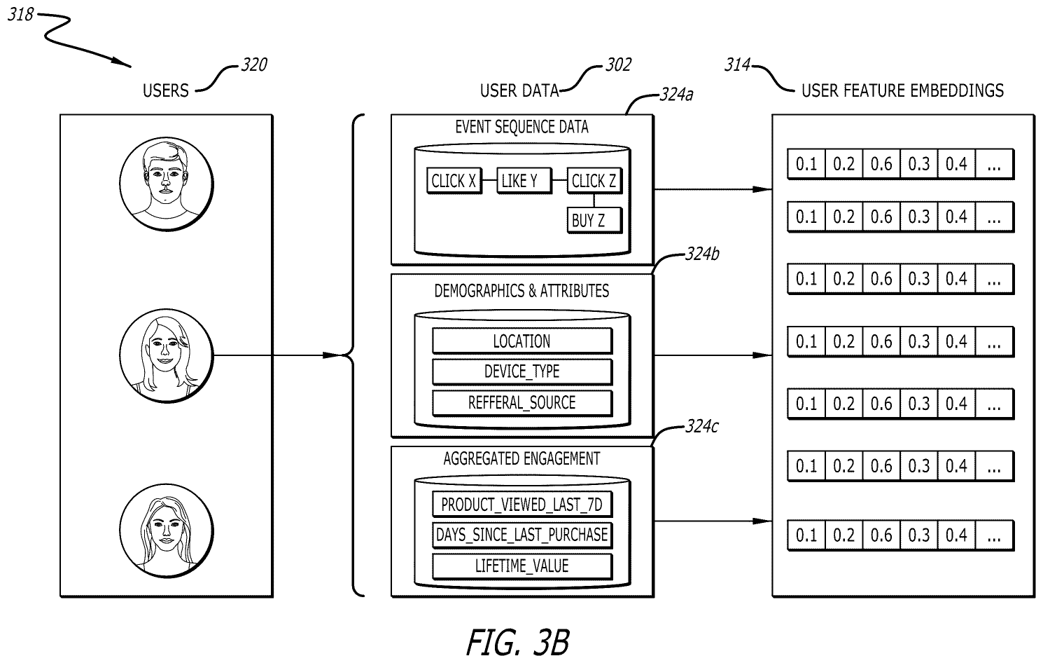

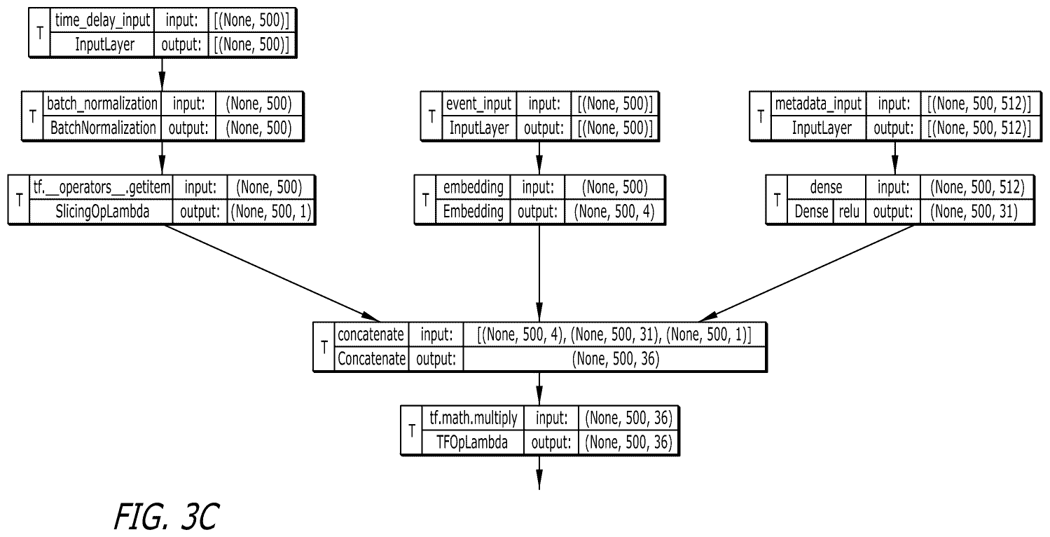

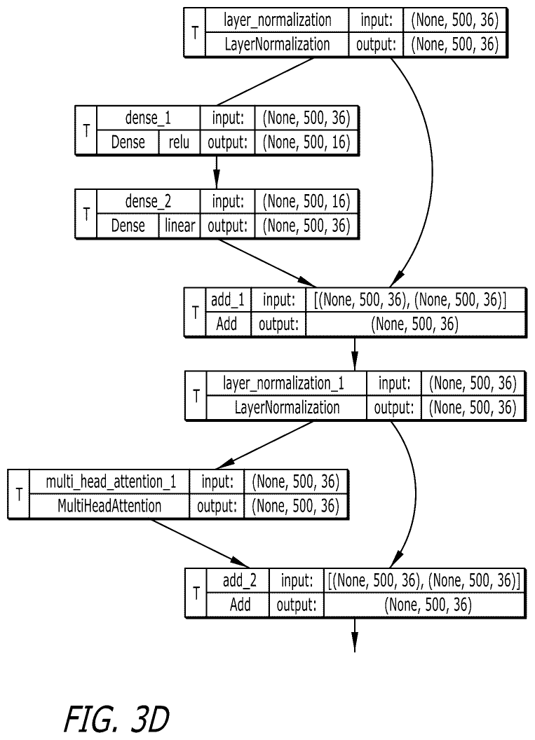

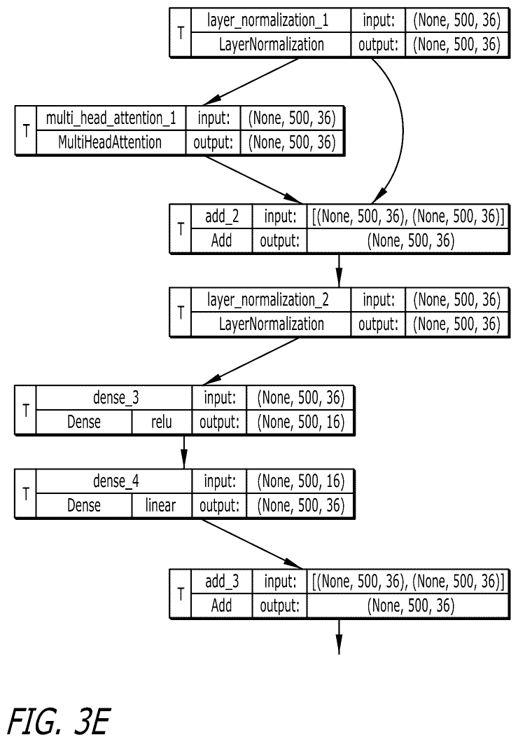

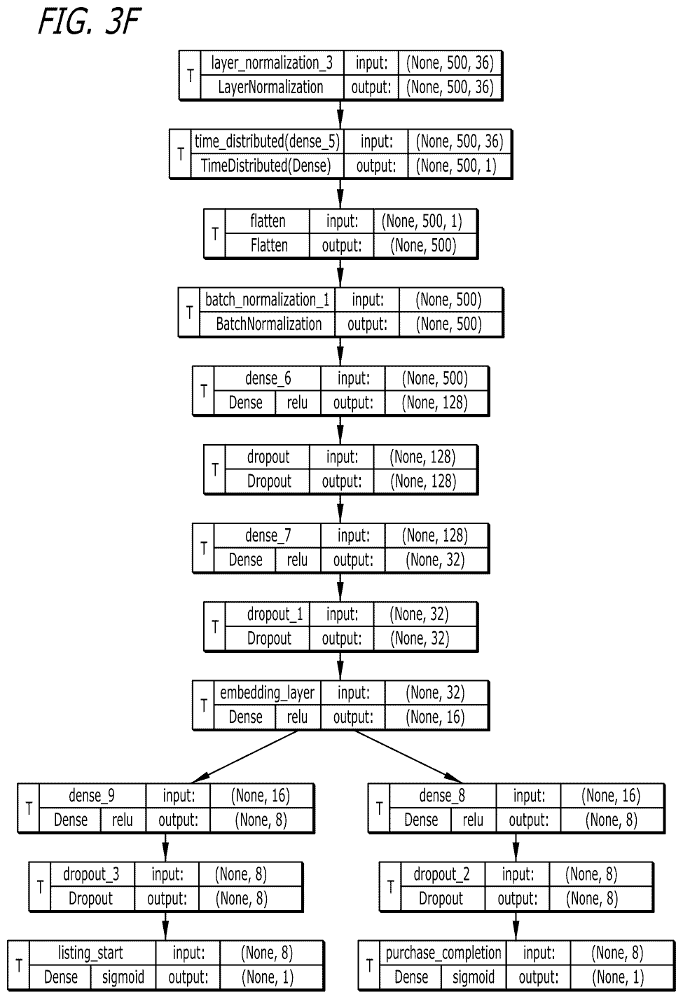

Referring to now FIG. 3A, a data flow during a user feature creation process is shown according to some embodiments. FIG. 3A illustrates a data flow 300 that includes a plurality of components illustrating the process of determining aggregated features and vector embeddings from ingested user data. As shown, the components include a user data ingestion component 302 that includes user event data 304a and user attribute data 304b, an optional PII filter 306, a feature engineering component 308, a vector embedding generation component 312 comprising one or more deep learning models and/or transformers, and a first training data set that includes aggregated features 310 and user embeddings 314, which are eventually stored in a datastore 316.

In some embodiments, as user data 302 is ingested, the treatment selection engine 102 may apply a PII filter 306, which as discussed above, removes PII from the ingested user event data 302. As noted above, the ingestion logic 210 may ingest the user event data and apply the PII filter 306. The ingested user data 302, following the optional application of the PII filter 306, is then processed through the feature engineering component 308 and/or the vector embedding generation component 312, where such processing may be performed by the feature generator 215.

The feature engineering component 308 may perform operations resulting in the generation of aggregated user features 310. The generation of the aggregated user features 310 may include parsing the user data 302 for predetermined features such as a number of days since a free trial started, an order value, a referral source, a category from which a user last purchased, etc. These features may be extracted from each log (e.g., each user may have his/her own log) and are then aggregated by the feature engineering component 308 resulting in the aggregated features 310. For example, a feature corresponding to a number of days since a free trial started may be an average of a number of days since a free trial started among all user data. Additionally, another aggregated feature may be an average order value among all user data. For categorical features (as opposed to numerical features previously referenced), a vector may be constructed indicating a number of occurrences for a plurality of items such as a number of occurrences of a defined set of possible referral sources.

The generation of user embeddings 314 may include operations performed by the feature generator 215 including preprocessing operations and an embedding operation. In some examples, the preprocessing operations may be dependent on the structure of the ingested user data 302. For instance, in embodiments in which the ingested user data 302 is set forth in one or more tables (e.g., rows and columns of data), the preprocessing operations may include detecting and accounting for missing values, scaling numerical fields, encoding categorical fields (e.g., via one-hot encoding), etc. In some embodiments, when text data fills table entries, additional operations may be performed on each such table entry including tokenization, removal of stop words, stemming, lemmatization, etc. In some embodiments, accounting for missing values may include filling missing values with a default number, such as 0, 1, 10, etc. In other examples, accounting for missing values may include taking an average of surrounding values, e.g., an average of 1-3 values of preceding entries and 1-3 values of subsequent entries. Other variations of an average of surrounding values may also be utilized.

Examples of performing the embedding operation on data 302 may include the use of a neural network such as one of a plurality of autoencoder architectures. For example, optional autoencoder architectures that may be utilized include sequence models-based encoders such as recurrent neural networks or transformer encoders and encoder-to-multilabel output architectures. With respect to encoder-to-multilabel output architectures, the configuration may include an encoder configured to extract features from a treatment and condense the features into a lower-dimensional latent representation, which is provided to a classifier for label prediction. The predicted labels in this instance correspond to predictions as to whether a sequence or a specific event occurs based on provided input. In some instances, the architectures may utilize different loss functions such as a categorical cross-entropy function.

Referring now to FIG. 3B, detail as to the generation of user feature embeddings is shown according to some embodiments. FIG. 3B illustrates a data flow 318 that illustrates the generation of user embeddings 314. A set of users 320 may refer to users that have interacted with the third-party digital platform 110, e.g., a set of users that have used a grocery shopping app that enables the user to add grocers to a digital shopping cart, electronically check out (e.g., providing payment via a credit card, the information of which is stored with the grocery shopping app), and pick up the groceries or receive such via delivery. In some examples, at least a subset of the users have established an account with the third-party digital platform 110. Thus, the app may be configured to obtain user data 302 including event sequence data 324a, demographics and attributes 324b, and aggregated engagement 324c, where the event sequence data 324a and the aggregated engagement 324c may be stored within the event data datastore 104.

In some embodiments, the third-party digital platform may monitor user input event sequence data 324a such as the interactions performed by the user with a product surface of the app and often track the sequence of interactions. Example interactions shown in FIG. 3B may include various clicks within the app or emails that are links to the app, clicks within a webpage of the grocery store, “likes” (or “dislikes”) or other user feedback, and purchase. The user account may also provide demographics and user attributes 324b such as location of the user while using the app, device type, referral type (e.g., product surface), age, gender, and/or other demographics. Further, aggregated engagement statistics 324c may also be obtained as an aggregation or compiled listing of the products viewed over a defined time period, e.g., 7 days (but such may also be products liked, products purchased, products added to cart, coupons utilized, coupons not utilized, etc.), an aggregate number of days since a last purchase, a lifetime value of products purchased, etc. In some examples, each of the aggregations or compilations may be according to categories such as apparel, footwear, headwear, jewelry, deli items, fruits, vegetables, frozen foods, etc., where the categories may be predefined by the customer associated with the third-party digital platform (grocery store, clothing store, electronic department store, hardware store, restaurant, etc.).

The treatment selection engine 102, and in some embodiments, the feature generator 215, processes the sequence data 324a, demographics and attributes 324b, and aggregated engagement 324c to generate user embeddings 314. In some examples, the treatment selection engine 102 deploys machine learning (deep learning/transforms 312) to generate at least a portion of the user embeddings 314. The machine learning model may be configured to processes a sequence of events 324a and learn embeddings therefrom, where the embeddings are learned via performing a prediction task. The prediction task may include predicting a sequence (e.g., the model is provided the event logs of the last 7 days and trained to predict the event logs for the next 7 days) or key event occurrences (e.g., the model is provided the event logs of the last 7 days and trained to predict a subsequent action from a set of predefined actions such as “add to cart,” “share,” “purchase,” etc.). In some embodiments, categorical cross entropy is utilized as the loss function.

In order to construct a machine learning model configured and trained to process a sequence of tokens, an architecture that is suitable for modeling sequential information has been selected. In some examples, architectures such as recurrent neural networks (RNN) and long short-term memory (LSTM) may be utilized. In other examples, a transformer architecture is utilized to model sequential information. Examples of transformer architectures include an encoder-decoder structure, an encoder-only structure (Bidirectional Encoder Representations from Transformers, BERT), or a decoder-only structure (generative pre-trained transformer, GPT). In one particular embodiment, a proprietary transformer model has been configured and trained to process last n-day event logs (input) and predict key high value events in the next m-days (output). Via a supervised learning process, the transformer architecture learns an effective embedding. As one illustrative example, the transformer architecture disclosed herein includes 28 layers between input and output. One illustrative example of such a transformer architecture configured and trained for the specific purposes described herein is provided in FIGS. 3C-3F.

In yet other embodiments, an autoencoder architecture may be utilized in which an encoder layer is configured to process input (e.g., a sequence of event from event logs) generating a compressed representation of the input and a decoder layer configured to predict the input back. The compressed representation may be referred to as the latent space representation or an embedding of the input data. In such embodiments, an unsupervised learning approach is utilized.

In some examples, user demographic and user attribute data 324b is represented as text and provided to a large learning model (LLM) along with a prompt instructing the LLM to generate an embedding therefrom. In some instances, the prompt may utilize chain-of-thought (CoT) prompting. Similarly, embeddings of aggregated engagement data 324c may be generated through prompting of a LLM for such.

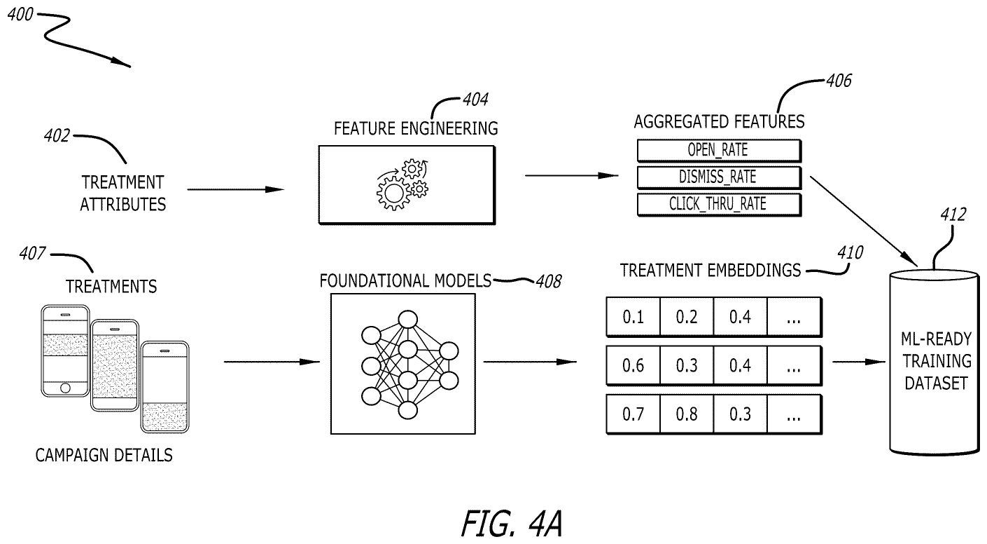

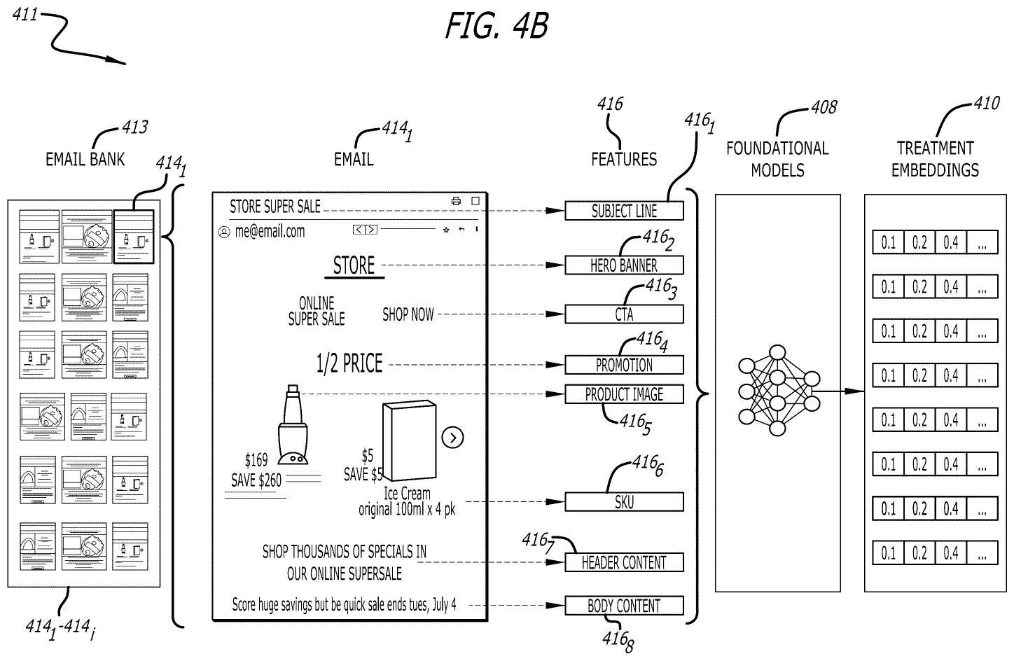

Referring to FIG. 4A, a data flow during a treatment feature creation process is shown according to some embodiments. FIG. 4A illustrates a data flow 400 that includes a plurality of components illustrating the process of determining aggregated treatment features and treatment embeddings from ingested treatments, e.g., historically provided treatments and corresponding treatment attributes. As shown, the components include treatment attributes 402 and treatments 407 that include various historical treatments such as banners, app display screens, notifications, webpages, etc. The components further include a feature engineering component 404 configured to generate treatment aggregated features 406 and one or more large language models (LLMs) or machine learning models (“foundational models”) 408 that are configured to generate treatment embeddings 410. The treatment aggregated features 406 and the treatment embeddings 410 may both be stored in a datastore 412 (which may be the same as or distinct from the datastore 316 of FIG. 3A). In some embodiments, as with the ingestion of the user data 302 in FIG. 3A, the treatment selection engine 102, or more particularly, the ingestion logic 210, may ingest the historical treatments, which are then processed by the feature engineering component 404 and the foundational models 408, where such processing may be performed by the feature generator 215. In some embodiments, the term foundational model refers to a machine learning model that has been trained on a vast amount of data, typically having a large number of parameters (e.g., millions or billions). Often times, but not always, a foundational model has been trained via self-supervised learning such as through prediction of missing words in a sentence or of a next action in a sequence of actions. Examples of foundational models include, but are not limited or restricted to, Bidirectional Encoder Representations from Transformers (BERT), generative pre-trained transformer (GPT), etc. As used herein, the term foundational model may encompass LLMs, e.g., LLMs being a subset of possible foundational models. LLMs may be utilized to indicate a specific use case. Additionally, beyond machine learning models typically understood to be foundational models due to their large size, other machine learning models may also be utilized in place of foundational models such as Word2Vec (a word embedding model configured to convert words into fixed-size vectors (embeddings) that capture semantic and syntactic similarities between words) or Doc2Vec (a document embedding model configured to generate dense, fixed-length vector representations (embeddings) for variable-length pieces of text, such as sentences, paragraphs, or entire documents).

The feature engineering component 404 may perform operations resulting in the generation of aggregated treatment features 406. The generation of the aggregated treatment features 406 may include parsing the treatment attributes 402 for predetermined features such as an open rate, a dismiss rate, a click through (thru) rate, an absolute number of views, an absolute number of clicks, an adoption rate (e.g., treatment includes instructions that are followed by a user), etc. These features may be extracted for each treatment (e.g., a particular treatment has attributes specific to an open rate, such as a percentage of how many users provide user input selecting the particular treatment). The extracted features are then aggregated by the feature engineering component 308 resulting in the aggregated features 310. For example, a feature corresponding to an absolute number of clicks may be a sum of all clicks on a particular treatment for all users (all time or for a given time period).

The generation of treatment embeddings 410 may include operations performed by the feature generator 215 including preprocessing operations and an embedding operation. In some examples, the preprocessing operations may be dependent on the structure of the treatments 407. For instance, in embodiments in which the treatments 407 are a mix of alerts, notifications, or messages that each may include text and/or graphics, the preprocessing operations may include identifying text and performing tokenization, removal of stop words, stemming, lemmatization, etc. The pre-processing operations may also include identifying images and performing normalization, resizing, etc. Examples of performing the embedding operation on text data within a treatment may include the use of a neural network that learns weights through training data by predicting context of words or aspects of a document (where a treatment may be considered a document) and creates embeddings based on the weights (e.g., Word2Vec or Doc2Vec). Transformers may also be utilized to create embeddings, such as BERT or GPT. With respect to images included in the historical treatment, convolutional neural networks (CNNs) may also be used to extract features and represent such as embeddings (e.g., vectors). In some embodiments, a prompt may be provided to a large language model (LLM) instructing the LLM to generate embeddings from one or more treatments. The prompt may instruct the LLM on context of the treatment resulting in the generation of more pertinent embeddings. In some instances, a chain of thought (CoT) prompting technique is utilized where the prompt instructs the LLM to break down the problem of determining embeddings into smaller steps with instructions such as: first just start with the raw treatment content; and second, provide additional prompts on the product, behaviors we want to drive. Details about the customer include examples for what application-type is the treatment being provided (example categories include e-commerce, fitness app, etc.), the actions to drive (examples include make a purchase, join a subscriptions service, share a product, etc.), metrics on each treatment (e.g., click rate).

Referring to FIG. 4B, detail as to the generation of treatment feature embeddings is shown according to some embodiments. FIG. 4B provides a data flow 411 that illustrates the generation of treatment embeddings 410. In the example of FIG. 4B, the email bank 413 corresponds to the treatments 402 of FIG. 4A and is comprised of a plurality of emails (treatments) 414₁-414i (collectively or individually, “414”). In some embodiments, the email bank 413 includes a collection of many or all past emails transmitted by a third-party digital platform to users. As should be understood, the email bank 413 represents one example of possible treatments.

FIG. 4B shows email 414₁ being used as an illustrative example for the extraction of features 416 including, but not limited or restricted to, a subject line 416₁, a hero banner 416₂, a call to action user interface (UI) component 416₃, a promotion 416₄, a product image 416₅, a stock keeping unit (SKU) 416₆, header content 416₇, and body content 416₈. The features 416 are then processed by a foundational model 418, which generate the treatment embeddings 420 based on unstructured data such as that shown in the email bank 413. In some embodiments, the foundational model 418 represents a large, pre-trained machine learning model with examples including large language models (LLMs) and You Only Look Once (YOLO) models.

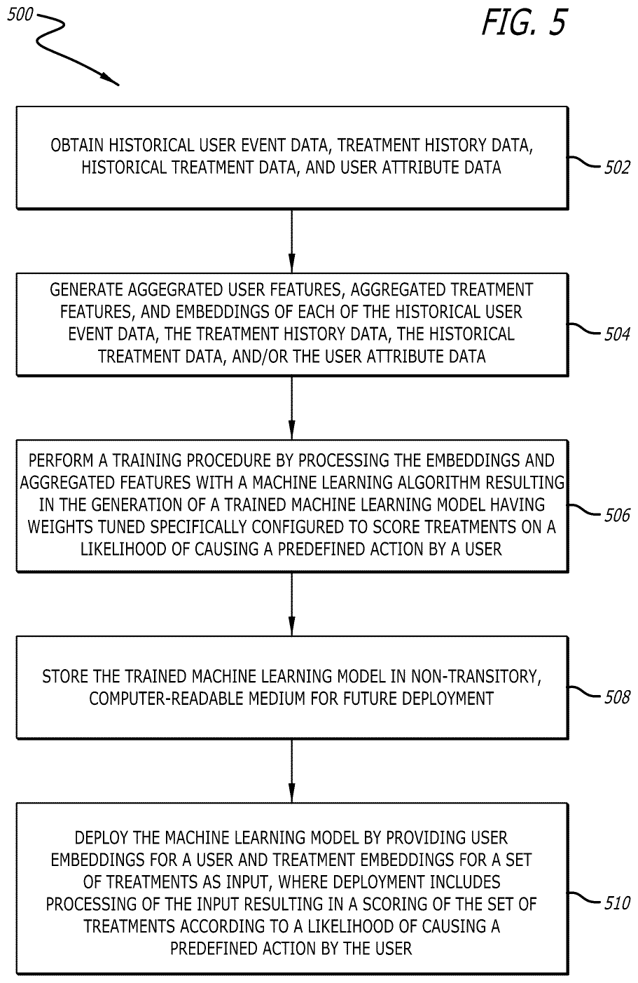

Referring now to FIG. 5, a flowchart illustrating operations of a process for training a machine learning model with user feature embeddings and treatment feature embeddings is shown according to some embodiments. The process 500 provides a high-level depiction of operations performed in training a machine learning model with user embeddings, aggregated user features, treatment embeddings, and aggregated treatment features. Each block illustrated in FIG. 5 represents an operation in the process 500 performed by, for example, a treatment selection engine 102 of FIG. 1. It should be understood that not every operation illustrated in FIG. 5 is required. In fact, certain operations may be optional to complete aspects of the process 500. The process 500 begins with obtaining historical user event data, treatment history data, historical treatment data, and user attribute data (block 502).

As discussed above, aggregated treatment features, aggregated user features and embeddings of each of the historical user event data, the treatment history data, the historical treatment data, and/or the user attribute data are then generated (block 504). For instance, the feature generator 215 of the treatment selection engine 102 may perform the embeddings. While detail of the embedding generation processes is illustrated for the user event data, user attribute data, and historical treatment data, a similar process is also performed for the treatment history data, which provides a date and timestamp, a treatment identifier, and a user identifier, which indicates when a particular treatment was served (provided) to a particular user.

A training procedure is then performed by the treatment selection engine 102 including processing the embeddings with a machine learning algorithm resulting in the generation of a trained machine learning model having weights tuned specifically configured to score treatments on a likelihood of causing a predefined action by a user (block 506). The training procedure may be performed by the model set up and training logic 220 as shown in FIG. 2. The user event data provides a history of a particular user's actions such as clicks, user input, feedback, purchases, etc., with a third-party digital platform (e.g., event sequence data 324a). By obtaining and correlating treatment history for a given time period and user event data for at least the given time period accounting for user actions following the serving of a treatment, the machine learning model generates and tunes weightings according to a historical flow of particular treatments served to particular users in view of the response (or lack thereof) provided by each user. Thus, the trained machine learning model is comprised of weights that generate higher scores for treatments that are predicted to result in a predefined action (e.g., make a purchase of an advertised item or upgrade a subscription plan from a free to a paid version). In some examples, a trained machine learning model may be configured to score treatments in view of user attributes according to a single predefined action. In some examples, the treatment selection engine 102 is configured with a plurality of machine learning models trained to provide scoring according to different predefined actions. In other examples, the treatment selection engine 102 is configured with a single machine learning model configured to score treatments in view of user attributes according to a plurality of predefined actions.

The trained machine learning model is then stored in non-transitory, computer-readable medium for future deployment (block 508). Subsequently, the machine learning model is then deployed by providing user embeddings for a particular user associated with a treatment request and treatment embeddings for a set of treatments as input, where deployment includes processing of the input resulting in a scoring of the set of treatments according to a likelihood of causing a predefined action by the user (block 510).

### III. Generation of a Treatment Recommendation

The treatment selection engine 102 as illustrated in FIGS. 1-2 includes a treatment determination logic 230 comprised of a decisioning system logic 240 and a delivery system logic 245 introduced above. As will be discussed in detail below and with reference to FIGS. 1-2, the treatment determination logic 230 is configured to receive a treatment request 292 from a third-party digital platform 280. The treatment determination logic 230 is configured to process the treatment request 292 and, in response, provide a treatment recommendation that may be a single treatment to provide to a particular user or may be a list of a plurality of treatments to provide to the particular user. In some examples, the listed is a ranked list. In some additional examples, the treatment recommendation may include the recommendation treatments, e.g., software code that, upon execution by one or more processors, requests in display of a notification, alert, text, graphic, or combination thereof on a display screen of a network device of the particular user.

In many embodiments, the treatment determination logic 230 obtains treatments that may be recommended to the user and user data. The user data may be retrieved by using a user identifier received with the treatment request to obtain user attributes and treatment history for the user. A set of eligibility rules may be generated based on the treatment history and user attributes and subsequently applied to the treatments, which may reduce the possible treatments to a candidate subset of treatments. The treatment determination logic 230 may then deploy one or more machine learning models by generating embeddings for the candidate subset of treatments and the user data and providing the embeddings as input to a machine learning model. The machine learning model processes the embeddings resulting in a score for each of the treatments, where the score represents a likelihood that providing the treatment to the user will cause the user to perform a particular action (e.g., purchase an item advertised in the treatment). The treatment determination logic 230 then generates a ranked list of the treatments based on the machine learning generated scores and, optionally, predefined scoring rules that may alter the ranked list. The ranked list, or a portion thereof, may be provided to the third-party digital platform along with one or more treatments on the ranked list.

Referring now to FIG. 6, a data flow for performing a treatment recommendation based on user feature embeddings and treatment feature embeddings is shown according to some embodiments. FIG. 6 illustrates a data flow 600 that depicts the decisioning system logic 240 deploying a machine learning model 602, which includes providing treatment embeddings 610 and user embeddings 620 as input to the model 602. The model 602 is illustrated as being trained to provide a scoring of a candidate subset of treatments associated with the treatment embeddings 610 where a score assigned to a particular treatment indicates a likelihood that the particular treatment with cause the user associated with the user embeddings 620 to take any of three predefined actions 604, 606, 608: save an item to a digital cart; activate a promotion; or share a product through a social media platform.

FIG. 6 illustrates an example listing 630 of the candidate subset of treatments and a corresponding score. As discussed throughout the description, the listing 630 may be ranked according to the score provided by the model 602, and the ranking may thereafter be altered based on predefined ranking rules. The listing 630 includes a set of columns including a treatment column 632 providing a treatment identifier and a score column 634 providing a score generated by the model 602 that is indicative of a likelihood that serving of the corresponding treatment (e.g., displaying the treatment to a user via a network device) will cause performance of an objective. The objective may be a defined desired task such as purchasing an item or upgrading to a subscription account from a free trial. In other embodiments, the objective may be a series of tasks such as sign up for a free trial and share a coupon, code, or link to another user.

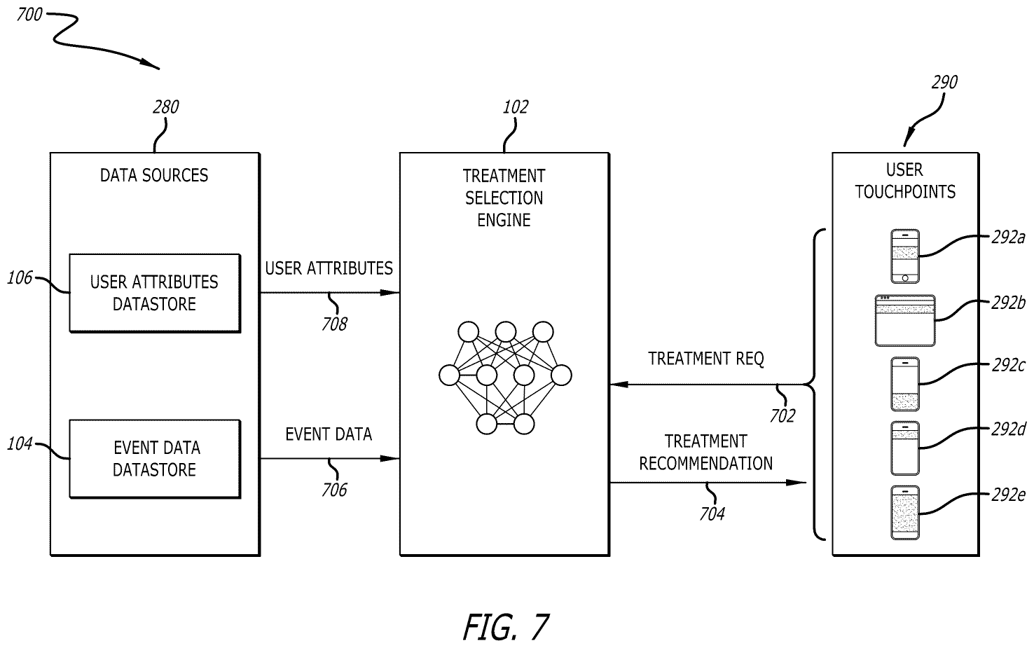

Referring to FIG. 7, a diagrammatic illustration of a data flow resulting from receipt of a treatment request is shown according to some embodiments. FIG. 7 illustrates a flow 700 that includes a treatment request 702 transmitted to the treatment selection engine 102 from a third-party digital platform 280. The treatment selection engine 102 obtains user attributes 708 and event data 706 from one or more data sources 280. The treatment selection engine 102 processes the user attributes 708 and event data 706 through deployment of one or more machine models resulting in a scoring of a set of treatments that may be provided to the third-party digital platform 280. The treatment selection engine 102 may generate a ranked list of the treatments based on the machine learning scoring and, optionally, perform additional processing on the ranked list to alter the rankings and/or remove certain treatments from the list. For example, one or more predefined rules may indicate that when a particular treatment is assigned a score about a particular threshold, that treatment is automatically moved to the top of the ranked list. As another example, a rule may exist that indicates only one treatment assigned to a particular exclusion group may be included on a ranked list provided to the third-party digital platform 280. In such an example, the ranked list may be altered to remove any treatments that are not the highest ranked treatment for a particular exclusion group.

Referring back to FIG. 7, a set of selected treatments and the ranked list are provided to the third-party digital platform as a treatment recommendation 704. The selected treatments within the treatment recommendation 704 may include displays, alerts, notifications, banners, etc. that are displayed in any of the user touchpoints 292a-292e.

Referring now to FIG. 8, a detailed logic diagram of the treatment selection engine is shown according to some embodiments. FIG. 8 illustrates the coupling between an endpoint device 800, the treatment selection engine 102, and one or more data sources 280. The endpoint device 800 may be, for example, a mobile device that includes an application 802 operating thereon and is configured to communicate with the treatment selection engine 102 as well as monitor user events and obtain user attributes. Additionally, the endpoint device 800 may include data delivery logic 804 configured to deliver one or more treatments to a user of the endpoint device 800. In some embodiments, the data delivery logic 804 may be a sub-module of the application 802.

Additionally, FIG. 8 illustrates a detailed breakdown of logic modules that comprise the treatment selection engine 102. In particular, the treatment selection engine 102 is shown to comprise a data pipeline logic 200, a model setup and training logic 220, a treatment determination logic 240, an experimental service logic 270, and datastores 850.

As discussed above, the data pipeline logic 200 includes a feature generation logic 215 (or “feature generator”) and an ingestion logic 210. The feature generation logic 215 may include an event data aggregation logic 812 and an event data retrieval logic 814. The event data retrieval logic 814 is configured to obtain event data associated with a user of the endpoint device 800 from the event/user attribute datastores 104, 106 and the event data aggregation logic 812 may aggregate various fields comprising the data. For example, the event data aggregation logic 812 may aggregate a number of purchases made by the user within a defined time period, a number of items added to a digital shopping cart within a defined time period, a total monetary amount spent over a defined time period, etc. Similarly, the ingestion logic 210 may include a user attribute retrieval logic 822 that is configured to retrieve user attribute data. Embeddings may be generated from the event data and user attribute data and stored in the datastores 850.

The datastore(s) 850 may be configured to store various data in one or more datastores including treatment history data 851, aggregated event data 852, treatments 853, aggregated user attribute data 854, machine learning models 855, experiment data 856, event data 857, etc. The data described above may also include embeddings generated therefrom. As should be understood, the datastore(s) 850 may be a single datastore or comprised of several separate datastores.

As noted above, the treatment determination logic 240 may be comprised of a decisioning system logic 250 and a delivery system logic 255. The decisioning system logic 250 may be comprised of sub-logic modules that are configured, upon execution by one or more processors, to perform operations of receiving a treatment request (decision service logic 830), obtaining treatments (treatment service logic 832), user attributes (user attribute service logic 839) and treatment history (treatment history service logic 834), and applying eligibility rules to obtain a candidate subset of treatments (decision service logic 830).

Upon determining the candidate subset of treatments, the candidate subset of treatments and embeddings generated from the user attributes, user event data, and treatment history data are provided to a machine learning model as input that processes the input resulting in generation of a score for each treatment of the candidate subset of treatments (model deployed by the prediction service logic 836). A ranked list of the candidate subset of treatments is then formed and, optionally, ranking rules are applied that may alter the ranking of one or more treatments (scoring service logic 838). The delivery system logic 255 then provides the treatment recommendation to a data delivery logic 804, which may separate logic from or part of the application 802. In some instances, the data delivery logic 804 may be stored on cloud computing services and relay the treatment recommendation to the application 802. Immediately prior to the transmission of the treatment recommendation, the snapshot logic 840 captures treatment history information such as the treatments provided, the ranked list, and a date and timestamp.

It is noted that FIG. 8 also illustrates that the application 802 monitors the user events and obtains user attributes, which are eventually received by the data sources 280. Although not shown in FIG. 8, FIG. 1 illustrates that data is provided from the third-party digital platform 110 to the treatment selection engine 102 via a “log treatment interaction API,” where the data may include information pertaining views, clicks, dismisses, and/or other interactions with specific treatments or specific buttons on treatment such as type of interaction, identification of relevant button if appropriate, and timestamp. Additional APIs may be utilized to transmit data between the application 802 and/or the third-party digital platform 110 of FIG. 1.

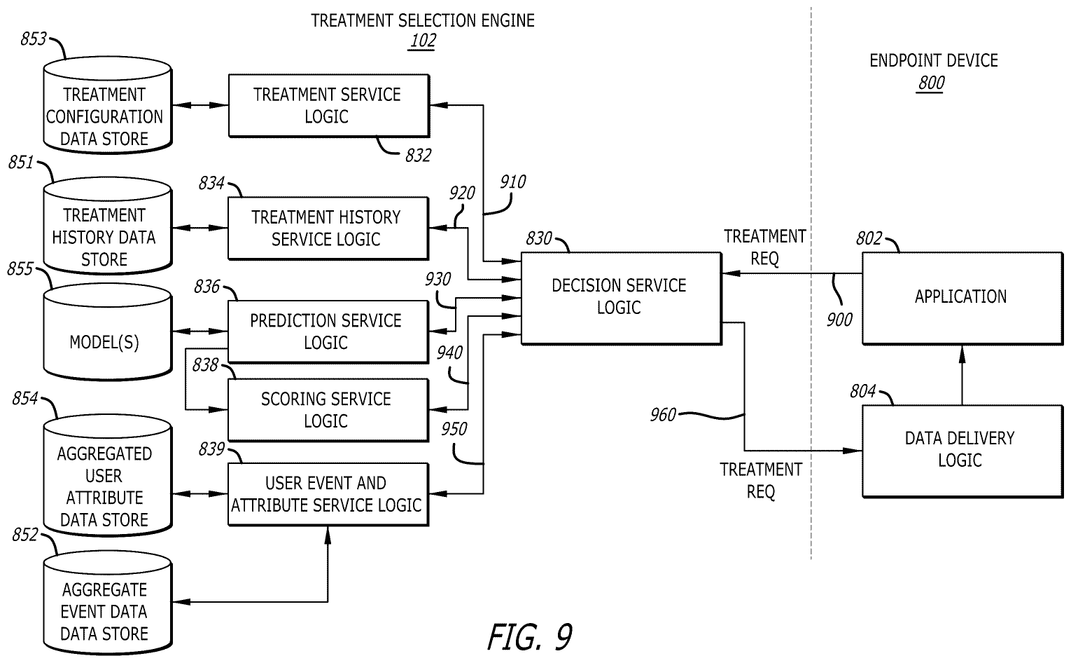

Referring to FIG. 9, a subset of the logic diagram of FIG. 8 illustrating logic modules utilized in determining a treatment recommendation is shown according to some embodiments. The logic diagram of FIG. 9 illustrates the flow of data through logic modules comprising the treatment selection engine 102. In particular, the FIG. 9 illustrates that a treatment request 900 transmitted from an endpoint device 800 is received by a decision service 830. The decision service logic 830 may then interface with a plurality of logic modules to determine possible treatments and narrowing such to a candidate subset of treatments, deploy machine learning models to obtain a score for each of the candidate subset of treatments, determine a ranked list of the candidate set of treatments, and provide a treatment recommendation back to the endpoint (or the third-party digital platform corresponding to the application 802).

More specifically, the decision service logic 830 may query a treatment service logic 832 with a request for treatments that have been preconfigured or predefined by or for the third-party digital platform corresponding to the application 802. The treatment service logic 832 may query the treatment configuration datastore 858 and retrieve and return such treatments to the decision service logic 830. The decision service logic 830 may then query a treatment history service logic 834 for treatment history of the user associated with the endpoint device 800 (and more specifically, a user account of the application 802), where the decision service logic 830 may provide a user identifier included in the treatment request 900. The user identifier may be used as a key to retrieve treatment history for the user stored as a key-value pair within the treatment history datastore 851, which is in turn relayed to the decision service logic 830. Further, the decision service logic 830 may query the user attribute service logic 839 for user event and attribute data corresponding to a user identifier. The user attribute service logic 839 obtains the user event and attribute data (940, 950) from the aggregate event data datastore 852 and the aggregated user attribute datastore 854, which are relayed to the decision service logic 830.

Through interfacing with the treatment service logic 832, the treatment history logic 834, and the user attribute service logic 839, the decision service logic 830 obtains possible treatments to be recommended to the application 802, treatment history of the user, and user event and attribute data. The decision service logic 830 may then apply a set of eligibility rules that may filter out a portion of the possible treatments as being ineligible for recommending to the user, where the eligibility rules may be based on user event and attribute data as well as treatment history as discussed above. The application of the eligibility rules may produce a candidate subset of treatments 930, which are provided to the prediction service 836. The prediction service 836 accesses the models 855 and deploys a machine learning model by providing embeddings of the candidate subset of treatments, treatment history of the user, and user event and attribute data as input to the machine learning model. In some embodiments, the embedding generation is performed by the decision service logic 830. In other embodiments, the embedding generation is performed by the prediction service logic 836.

The processing by the machine learning model results in a scoring for each of the candidate subset of treatments as discussed above. The scoring is provided to the scoring service logic 838, which is configured to generate a ranked list 940 of treatments of the candidate subset of treatments. In some examples, the ranked list 940 is formed from the scoring. In some instances, the ranked list 940 may then be altered based on predefined ranking rules (e.g., increase or decrease a position of one or more treatments on the ranked list 940). The decision service logic 830 then provides a treatment recommendation 960 to the endpoint device 800, either to a data delivery logic 804, which may be configured to receive the treatment recommendation 960 via one or more APIs, or the application 802 directly, which is configured to display one or more of the recommended treatments to the user via a display screen of the endpoint device 800.

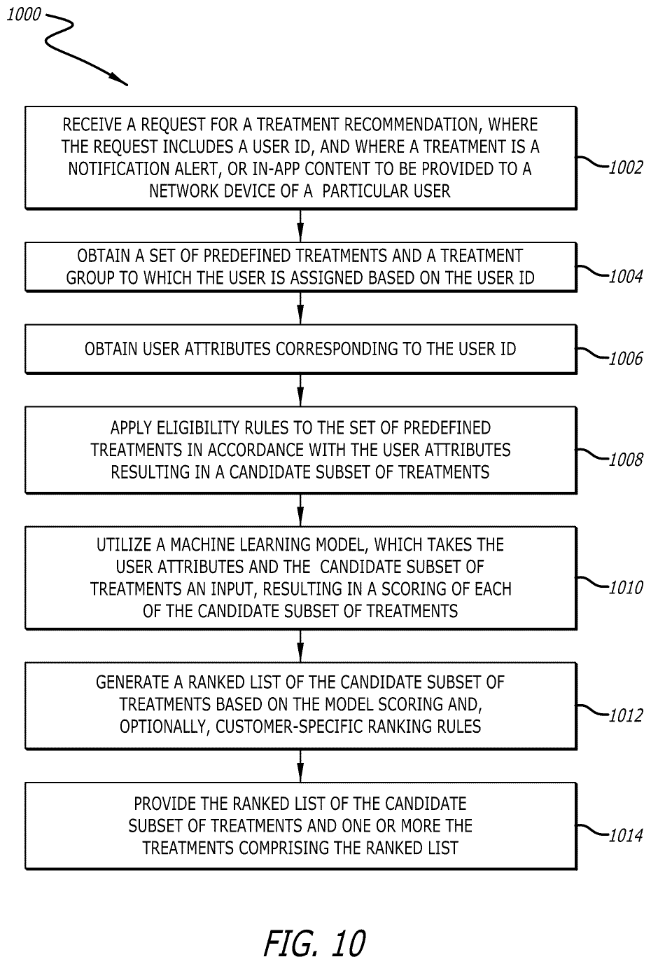

Referring now to FIG. 10, a flowchart illustrating operations of a process for determining a treatment recommendation is shown according to some embodiments. Each block illustrated in FIG. 10 represents an operation in the process 1000 performed by, for example, the treatment selection engine 102 of FIG. 1. It should be understood that not every operation illustrated in FIG. 10 is required. In fact, certain operations may be optional to complete aspects of the process 1000. The discussion of the operations of process 1000 may be done so with reference to any of the previously described figures. The process 1000 begins with receiving a request for a treatment recommendation (block 1002). In some embodiments, the request may include a user identifier (“user ID”) that corresponds to a user of a network device and associated with a user account with a third-party digital platform. As set forth above, a treatment may be a notification or alert to be provided to the network device of the user.

Following receipt of the request, the process 1000 may include operations of obtaining a set of predefined treatments and a treatment group to which the user is assigned based on the user ID and user attributes corresponding to the user ID (blocks 1004, 1006). As used herein, the term “user attributes” may include information such as gender, account, age, geographic location, coupons available to the user, aggregate counts of past purchases, settings configured by the user. As used herein, a predefined treatment (or treatment template) may refer to a predefined alert or notification that may be provided to a user such as a predefined email, banner, or alert. A predefined treatment may include graphics and text such as a textual description of a discount or sale on a particular item and an image of the item. In other instances, a portion of text may be predefined with additional, customized text to be filled in at the time the treatment is displayed, e.g., inclusion of the user's name. Example predefined treatments are illustrated in FIG. 4B as emails 414₁-414i in email bank 413 with one illustrative embodiment provided as email 414₁.

Subsequently, a set of eligibility rules may be applied to the set of predefined treatments in accordance with the user properties resulting in selection of a candidate subset of treatments (block 1008). The eligibility rules may be configured by the business entity corresponding to the third-party app, e.g., the grocery store, the apparel or footwear store, etc., where the business entity may be referred to as the “customer.” To note, the customer is distinct from the user. The eligibility rules themselves may dictate when a particular treatment may or may not be provided to a user. For example, eligibility rules may include redundancy rules that correlate the treatments the user has been shown within a given time period (e.g., 1 week, 1 day, etc.) and indicates such treatments are ineligible to be recommended to the user due to redundancy concerns. In some examples, treatments may be broken down into particular categories based on items that the treatment is promoting or discounting. Taking an apparel store customer as an example, treatments may include promotional offers that only certain users, such as first time purchasers, are eligible to redeem. The eligibility rules may rule all treatments containing such a promotional offer as ineligible for any user that previously made a purchase from the apparel store customer.

A machine learning model is then utilized (e.g., executed or applied) that takes the user attributes and candidate subset of treatments (or embeddings representative thereof) as input, where the model is specifically trained and configured to generate a scoring of each of the candidate subset of treatments (block 1010). As noted above, the score for a particular treatment may be indicative of a likelihood that serving of the corresponding treatment (e.g., displaying the treatment to a user via a network device) will cause performance of an objective. The objective may be a defined desired task such as purchasing an item or upgrading to a subscription account from a free trial. In other embodiments, the objective may be a series of tasks such as sign up for a free trial and share a coupon, code, or link to another user.

The treatment selection engine 102 then processes the scoring of the candidate subset of treatments to generate a ranked list that is based on the model scoring, and optionally, ranking rules that are specific to the third-party app from which the treatment request was received (block 1012). Similar to the eligibility rules discussed above, the ranking rules may be configured by the business entity corresponding to the third-party app, e.g., the grocery store, the apparel or footwear store, etc. (as defined above, “the customer”). The ranking rules themselves may alter the ranking of a particular treatment. For example, the ranking rules may indicate that if a particular treatment is within the candidate subset of treatments, then that particular treatment is automatically moved to the top of the ranking list. In other examples, the ranking rules may indicate that if the score of a particular treatment satisfies a threshold comparison (e.g., meets or exceeds a threshold score), the particular threshold is automatically moved to the top of the ranking list. Many other examples of alterations may be set forth in the ranking rules and the disclosure is not intended to be limited to the examples provided above. The ranked list of the candidate subset of treatments and one or more of the treatments on the ranked list is then provided to the third-party app for display on the network device (block 1014). In some embodiments, each treatment may be assigned to a particular exclusion group and only a single treatment per exclusion group may be recommended such that the ranked list is further altered to remove all but the top ranked treatment for a given exclusion group.

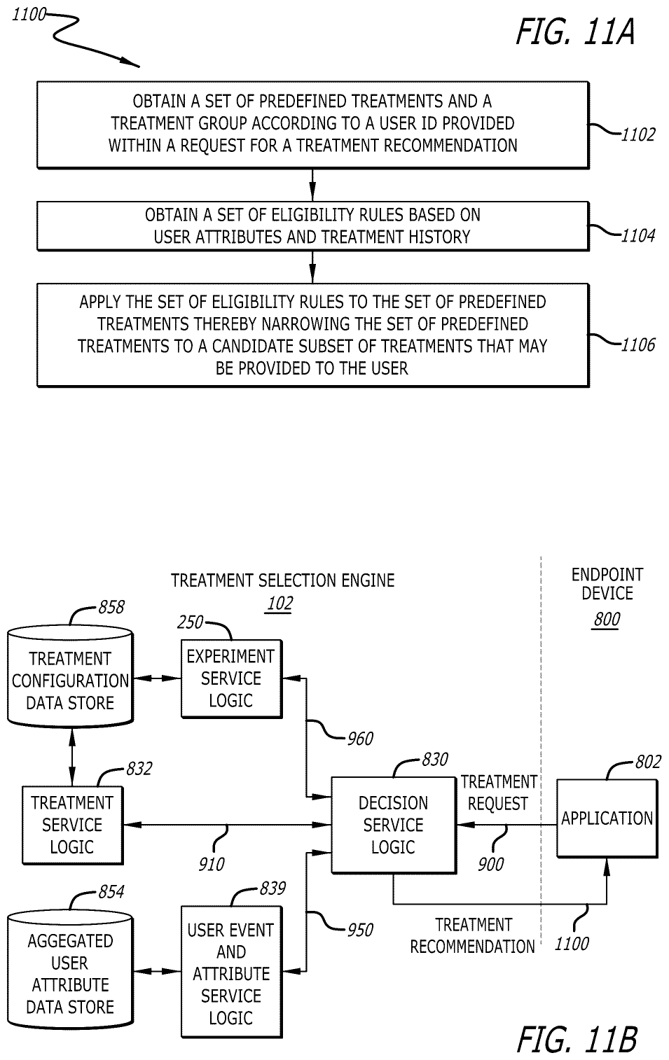

Referring now to FIG. 11A, a flowchart illustrating operations of an optional process for applying eligibility rules to a set of predefined treatments resulting in a candidate subset of treatments is shown according to some embodiments. Each block illustrated in FIG. 11A represents an operation in the process 1100 performed by, for example, the treatment selection engine 102 of FIG. 1. It should be understood that not every operation illustrated in FIG. 11A is required. In fact, certain operations may be optional to complete aspects of the process 1100. The discussion of the operations of process 1100 may be done so with reference to any of the previously described figures. The process 1100 begins with obtaining a set of predefined treatments and a treatment group (also referred to as an experiment group) according to a user ID that is included within a received request for a treatment recommendation (block 1102). Subsequently, a set of eligibility rules is obtained based on user attributes and treatment history (block 1104). In some examples, the set of eligibility rules may be selected from a larger pool of eligibility rules based on user properties and treatment history such as holding certain treatments ineligible for recommending to a user if treatment history indicates that the same treatment or a treatment within the same treatment exclusion group was provided to the user within a predefined time period (e.g., 7 days). Another example may include specific user feedback provided by the user indicating that certain treatments are disliked (e.g., via user feedback), where such treatment types are held ineligible (e.g., if a user unsubscribes from an email listserv). The user feedback may be stored as part of the user attribute data in some instances.

The set of eligibility rules is then applied to the set of predefined treatments, which reduces the set of predefined treatments to a candidate subset of treatments that may be provided to the user associated with the treatment request (block 1106). As should be clear from the discussion above, a third-party digital platform may request a treatment recommendation, which represents a recommendation of one or more treatments to provide to a user via one or more network devices. As discussed herein, the candidate subset of treatments is provided as input to one or more machine learning models, with each treatment therein being scored by the machine learning models and eventually ranked by the treatment selection engine, with the ranked list of treatments, or a portion thereof, being provided to the third-party digital platform as a treatment recommendation, and optionally, along with the recommended treatments themselves.

Referring to FIG. 11B, a subset of the logic diagram of FIG. 8 illustrating logic modules utilized in the process of FIG. 11A of applying eligibility rules to a set of predefined treatments is shown according to some embodiments. FIG. 11B illustrates a detailed breakdown of logic modules that comprise the treatment selection engine 102 and perform operations involved in the application of eligibility rules. Following receipt of a treatment request 900, the decision service logic 830 may obtain predefined treatments from a treatment service logic 832, where the treatments may be stored in a treatments data store 853 (shown in FIG. 8). Additionally, the decision service logic 830 may query an experiment service logic 250 for a treatment group to which the user belongs based on a user identifier within the treatment request 900, which may be stored in the treatment configuration datastore 858.

As discussed above, the decision system logic 830 may also obtain user event and user attribute data from the aggregated user attribute datastore 854 and aggregate event data datastore 852 via the user event and attribute service logic 839. Further, the decision system logic 830 may obtain or generate a set of eligibility rules based on the user attributes, treatment history, and, optionally, a treatment group. The eligibility rules are configured to reduce the possible treatments that may be provided to the user to a candidate subset thereof. Various examples are discussed throughout and may include noting certain treatments ineligible due to recently serving the same or similar treatment to the user, user feedback, etc. The candidate subset of treatments along with the treatment group, user attributes, user event data, and treatment history data may be provided to a prediction service logic 836 for scoring by a machine learning model as discussed throughout the disclosure.

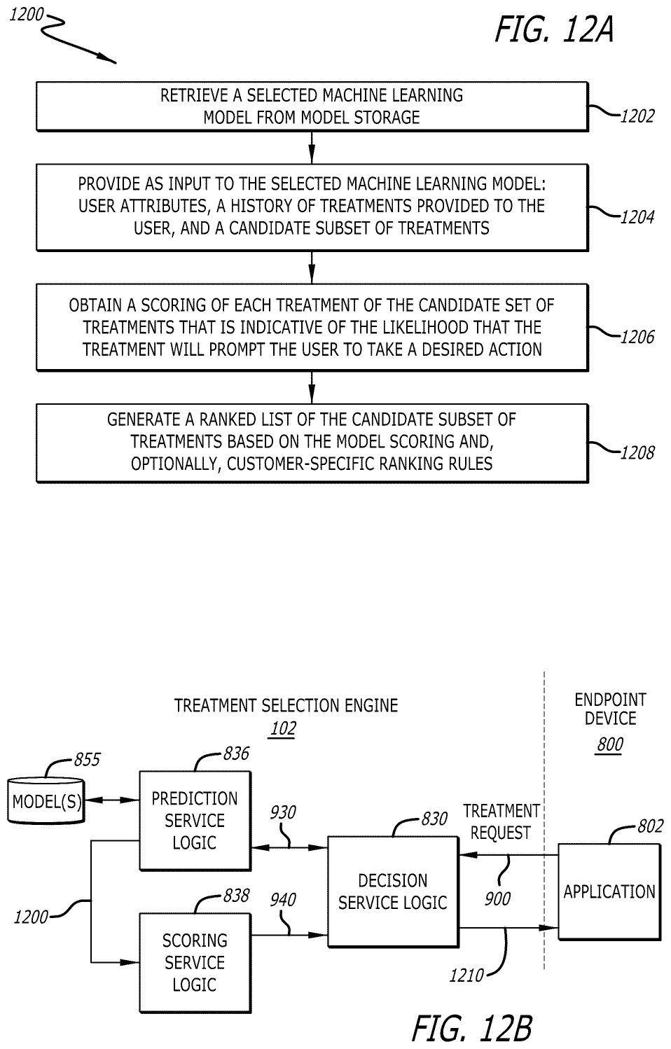

Referring now to FIG. 12A, a flowchart illustrating operations of deploying a machine learning model to score a candidate subset of treatments is shown according to some embodiments. Each block illustrated in FIG. 12A represents an operation in the process 1200 performed by, for example, the treatment selection engine 102 of FIG. 1. It should be understood that not every operation illustrated in FIG. 12A is required. In fact, certain operations may be optional to complete aspects of the process 1200. The discussion of the operations of process 1200 may be done so with reference to any of the previously described figures. The process 1200 begins with retrieving a selected machine learning model from model storage (block 1202). In some examples, a particular model is selected by the experiment service logic 250 based on an experiment group to which the user is assigned. For example, the users associated with a particular third-party digital platform may be assigned to different experiment groups in order to monitor which treatment recommendation process is most effective for a particular third-party digital platform. For instance, a first machine learning model may determine treatment recommendations most effectively for a third-party digital platform directed to grocery shopping, where “most effectively” refers to users performing a desired action in response to being provided a recommended treatment within a given timeframe at the highest rate as compared to other recommendation processes. In contrast, a second machine learning model or a heuristic-based approach may determine treatment recommendations most effectively for a third-party digital platform directed to scheduling rideshares.

Embeddings representing user attribute data, treatment history, user event data, and a candidate subset of treatments are then provided as input to the selected machine learning model for processing (block 1204). The selected machine learning model processes the input, which results in a scoring of each of the candidate subset of treatments, where a score is representative of the likelihood that a treatment will prompt the user to take a desired (predefined) action (block 1206). As noted above, the selected machine learning model is specifically trained and configured to perform such scoring, where the training of the selected machine learning model involved the generation of weights and biases for this purpose based on particularized training data. Based on the scoring, a ranked list of the candidate subset of treatments is generated (block 1208). In some embodiments, the ranked list may also be based on or altered in accordance with a set of custom ranking rules. In some instances, the custom ranking rules may be customer-specific.

Referring to FIG. 12B, a subset of the logic diagram of FIG. 8 illustrating logic modules utilized in the process of FIG. 12A of deploying a machine learning model to score a candidate subset of treatments is shown according to some embodiments. FIG. 12B illustrates that an application 802 operating on an endpoint device 800 (e.g., a network device such as a mobile device) transmits a treatment request 900 to the treatment selection engine 102, which is received by the decision service logic 830. As discussed above with respect to at least FIGS. 11A-11B, following receipt of the treatment request 900, a candidate subset of treatments 930 is determined, which are provided to the prediction service logic 836.

The prediction service 836 retrieves a selected machine learning model from the model storage 855 and provides a candidate subset of treatments 930, user attributes, user event data, and treatment history data to the selected machine learning model as input. As discussed above, the input may be in the form of embeddings, which may be generated by the prediction service logic 836, the decision service logic 830, and/or a feature generator 215 as shown in FIG. 2. The selected machine learning model processes the input resulting in a score for each of the candidate subset of treatments 930 (scores 1200).

The scores 1200 are then provided to the scoring logic 838, which generates a ranked list 940 of the candidate subset of treatments 930 based on the scores 1200 and, optionally, any predefined ranking rules corresponding to the third-party digital platform to which the application 802 belongs. The ranked list 940 is provided to the decision service logic 850, which may then provide the ranked list 940 and one or more of the recommended treatments on the ranked list 940 to the application 820 (collectively, treatment recommendation 1210).

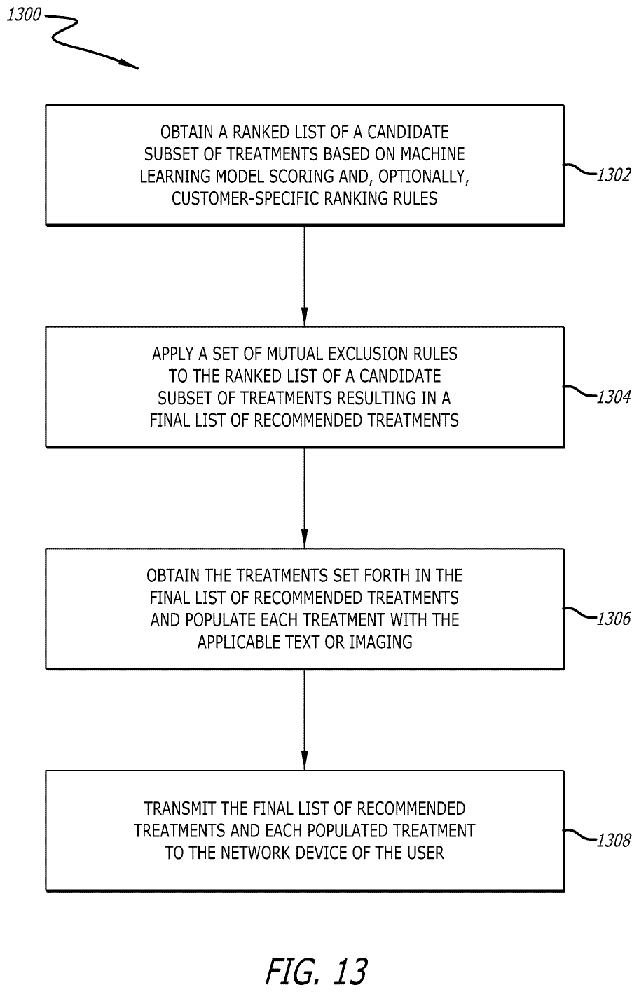

Referring to FIG. 13, a flowchart illustrating operations of applying a set of mutual exclusion rules to a ranked list of candidate subset of treatments is shown according to some embodiments. Each block illustrated in FIG. 13 represents an operation in the process 1300 performed by, for example, the treatment selection engine 102 of FIG. 1. It should be understood that not every operation illustrated in FIG. 13 is required. In fact, certain operations may be optional to complete aspects of the process 1300. The discussion of the operations of process 1300 may be done so with reference to any of the previously described figures. The process 1300 begins with obtaining a ranked list of a candidate subset of treatments based on machine learning model scoring and, optionally, customer-specific ranking rules (block 1302).

A set of mutual exclusion rules may then be applied to the ranked list of candidate subset of treatments resulting in a final list of recommended treatments (block 1304). In some embodiments, a mutual exclusion rule may reduce the ranked list of candidate subset of treatments by making a treatment ineligible if another treatment from the same mutual exclusion group had previously been selected for the user.

The treatments set forth in the final list of recommended treatments may then be obtained from treatment storage such that one or more of the treatments may be populated with the personalized or customized text or imaging (block 1306). For example, a treatment may be customized with a username, user email address, last purchased item, personalized promotion such as a discount code, a discount amount, a duration of a discount, etc. The final list of recommended treatments may then be transmitted to an application and/or a third-party digital platform generally (block 1308). Additionally, each of the recommended treatments may accompany the final list of recommended treatments and/or may be made accessible to a network device on which an application is processing.

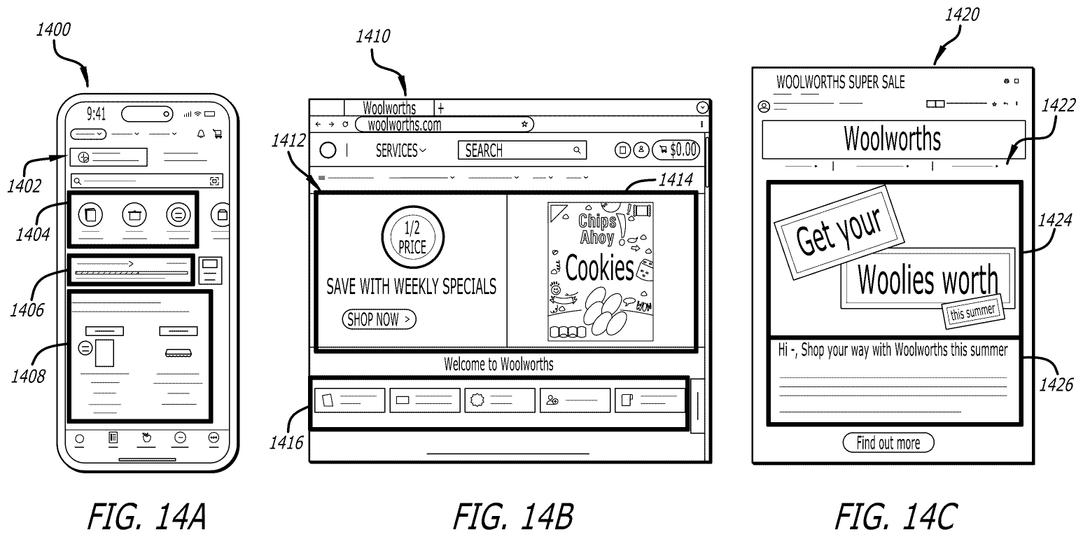

Referring to FIGS. 14A-14C, example treatments are shown according to some embodiments. Example product surfaces 1400, 1410, and 1420 are shown as displaying various treatments. Referring to FIG. 14A, the product surface 1400 is an application displayed on a first network device (e.g., a mobile phone), where the application may be, for example, a grocery delivery application. The application includes an indication of a delivery time 1402 and several treatments 1404, 1406, and 1408. The treatment 1404 includes selectable options that may provide options such as a link to a digital catalog, a link to recipes, or a link to a list of discounted items and may be referred to as a “content card.” The treatment 1406 includes an indication of a count of reward points and the treatment 1408 includes special offers (e.g., discounted items specifically for members for the particular user). In some examples, either of the treatments 1406 or 1408 may appear as a pop-up or overlay and displayed on top of content displayed within the application. In some embodiments, the treatment 1406 may be considered a “banner.” It should be understood that the content provided in any of the treatments 1402, 1404, or 1406 may be displayed outside of the application, such as via a banner on a home or locked screen of the network device.

Referring to FIG. 14B, the product surface 1410 is a webpage displayed within a web browser, e.g., on a network device such as a laptop computer. The webpage includes multiple treatments such as a call-to-action button 1412 (“Shop now>”), graphics 1414, and selectable options 1416 that may provide options such as a links similar to those shown in FIG. 14A.

Referring to FIG. 14C, the product surface 1420 is an email that may be displayed on a network device, e.g., a mobile phone or a laptop computer, such as within a web browser or in a mail client application. The email includes a body portion 1422 including a large graphic 1424, treatment 1426 providing personalized text, and a call-to-action button 1428 (“Find out more”).

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, data stores can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a computing device for execution thereby resulting in performance of the operations described in the flow chart by one or more components of the networked environments illustrated or described herein. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

What is claimed is:

1. A computerized method comprising:
receiving a request for a treatment recommendation, wherein the request includes a user identifier (ID), and wherein a treatment is a notification, alert, or message to be displayed by a network device;
retrieving (i) a set of user data from an aggregated user data table according to the user ID, and (ii) treatment data comprised of data related to a set of predefined treatments from a treatment datastore;
deploying a machine learning model configured to take the set of user data, a set of candidate treatments, and a configured objective as input and provide a scoring for each of the set of candidate treatments, wherein the set of candidate treatments is selected from the set of predefined treatments according to application of a set of eligibility rules, and wherein the machine learning model is trained and configured to score each of the set of candidate treatments according to the configured objective;
generating a ranked list of the set of candidate treatments based on the scoring provided by the machine learning model; and
providing the ranked list of the set of candidate treatments and the set of candidate treatments to the network device.

2. The computerized method of claim 1, wherein the request is received from a software application running on the network device.

3. The computerized method of claim 1, wherein selecting the set of candidate treatments includes applying the set of eligibility rules to the set of user data such that the set of candidate treatments is a subset of the set of predefined treatments.

4. The computerized method of claim 1, wherein the ranked list of the set of candidate treatments provided to the network device is stored in a treatment history datastore.

5. The computerized method of claim 1, wherein generating the ranked list of the set of candidate treatments includes applying a set of customer-specific ranking logic that alter a ranking of one or more of the set of candidate treatments.

6. The computerized method of claim 1, wherein generating the ranked list of the set of candidate treatments includes applying a set of mutual exclusion rules that prevents multiple treatments included within a predefined grouping from being provided to the network device.

7. The computerized method of claim 1, wherein the scoring provided by the machine learning model is indicative of a likelihood that each of the set of candidate treatments will prompt a user of the network device to take a desired action.

8. The computerized method of claim 1, wherein the set of user data is aggregated and transformed into a set of vector embeddings by machine learning models.

9. The computerized method of claim 1, wherein the treatment data is aggregated and transformed into a set of vector embeddings by machine learning models.

10. The computerized method of claim 1, wherein an assignment of a user to a control group or a treatment group is made after the treatment scoring and selection process has completed for that user.

11. The computerized method of claim 1, wherein a state of the set of user data at a time that one or more treatments is scored, selected and delivered to a user of the network device is recorded and stored.

12. The computerized method of claim 1, wherein the treatment includes a graphical image.

13. A computing device, comprising:
a processor; and
a non-transitory computer-readable medium having stored thereon instructions that, when executed by the processor, cause the processor to perform operations including:
receiving a request for a treatment recommendation, wherein the request includes a user identifier (ID), and wherein a treatment is a notification, alert, or message to be provided by a network device,
retrieving (i) a set of user data from an aggregated user data table according to the user ID, and (ii) treatment data comprised of data related to a set of predefined treatments from a treatment datastore,
deploying a machine learning model configured to take the set of user data, a set of candidate treatments, and a configured objective as input and provide a scoring for each of the set of candidate treatments, wherein the set of candidate treatments is selected from the set of predefined treatments according to application of a set of eligibility rules, and wherein the machine learning model is trained and configured to score each of the set of candidate treatments according to the configured objective,
generating a ranked list of the set of candidate treatments based on the scoring provided by the machine learning model, and
providing the ranked list of the set of candidate treatments and the set of candidate treatments to the network device.

14. The computing device of claim 13, wherein selecting the set of candidate treatments includes applying the set of eligibility rules to the set of user data such that the set of candidate treatments is a subset of the set of predefined treatments.

15. The computing device of claim 13, wherein the scoring provided by the machine learning model is indicative of a likelihood that each of the set of candidate treatments will prompt a user of the network device to take a desired action.

16. The computing device of claim 13, wherein the set of user data is aggregated and transformed into a set of vector embeddings by machine learning models, and wherein the treatment data is aggregated and transformed into a set of vector embeddings by machine learning models.

17. A non-transitory computer-readable medium having stored thereon instructions that, when executed by one or more processors, cause the one or more processor to perform operations including:
receiving a request for a treatment recommendation, wherein the request includes a user identifier (ID), and wherein a treatment is a notification, alert, or message to be provided by a network device;
retrieving (i) a set of user data from an aggregated user data table according to the user ID, and (ii) treatment data comprised of data related to a set of predefined treatments from a treatment datastore;
deploying a machine learning model configured to take the set of user data, a set of candidate treatments, and a configured objective as input and provide a scoring for each of the set of candidate treatments, wherein the set of candidate treatments is selected from the set of predefined treatments according to application of a set of eligibility rules, and wherein the machine learning model is trained and configured to score each of the set of candidate treatments according to the configured objective;
generating a ranked list of the set of candidate treatments based on the scoring provided by the machine learning model; and
providing the ranked list of the set of candidate treatments and the set of candidate treatments to the network device.

18. The non-transitory computer-readable medium of claim 17, wherein selecting the set of candidate treatments includes applying the set of eligibility rules to the set of user data such that the set of candidate treatments is a subset of the set of predefined treatments.

19. The non-transitory computer-readable medium of claim 17, wherein the scoring provided by the machine learning model is indicative of a likelihood that each of the set of candidate treatments will prompt a user of the network device to take a desired action.

20. The non-transitory computer-readable medium of claim 17, wherein the set of user data is aggregated and transformed into a set of vector embeddings by machine learning models, and wherein the treatment data is aggregated and transformed into a set of vector embeddings by machine learning models.
